(19) United States
(12) Patent Application Publication
(10) Pub. No.: US 2018/0181295 A1
(43) Pub. Date: Jun. 28, 2018

(54) METHOD FOR DISPLAYING INFORMATION, AND TERMINAL EQUIPMENT

(71) Applicant: Beijing Kingsoft Internet Security Software Co., Ltd., Beijing (CN)

(72) Inventors: Qingqing YU, Beijing (CN); Ruimin HUANG, Beijing (CN); Bo CHEN, Beijing (CN); Wen-Chen FENG, Beijing (CN); Hujia DUMAN, Beijing (CN); Ni GAN, Beijing (CN); Xinwei WU, Beijing (CN); Jiabo ZHOU, Beijing (CN); Xiaoming SUN, Beijing (CN); Ling YU, Beijing (CN)

(21) Appl. No.: 15/421,876

(22) Filed: Feb. 1, 2017

Related U.S. Application Data
(63) Continuation of application No. PCT/CN2017/071543, filed on Jan. 18, 2017.
Application No. PCT/CN2017/071543 is a continuation-in-part of application No. PCT/CN2016/111829, filed on Dec. 23, 2016.

(51) Int. Cl. G06F 3/0488; G06F 3/0481; G06F 3/0484; G06F 17/21

(52) U.S. Cl. CPC G06F 3/04883; G06F 17/212; G06F 3/04845; G06F 3/0481

(57) ABSTRACT

Embodiments of the present application disclose a method for displaying information, and a terminal equipment, wherein at least one information card is displayed on a display screen after a display instruction is received, the information card including information to be displayed. It means that an information card is displayed as long as a terminal equipment receives a display instruction, such that a user can browse information displayed on an information card without entering an application, and thus the operation is simple. In addition, the terminal device can also switch information cards after receiving a switching instruction to display more information to a user.

### CROSS REFERENCE TO RELATED APPLICATION

The present application is a continuation of International Application No. PCT/CN2017/071543, filed Jan. 18, 2017, which is a continuation-in-part of International Application No. PCT/CN2016/111829, filed Dec. 23, 2016. The entire contents of the above-referenced applications are incorporated into the present application by reference.

### TECHNICAL FIELD

The present application relates to the technical field of terminal equipments, and particularly to a method for displaying information, and a terminal equipment.

### BACKGROUND

At present, with more and more powerful functions of a terminal equipment, users can use a terminal equipment to perform a variety of operations, such as browsing news, viewing the weather, communicating with other users and so on. In general, users can install applications in a terminal to achieve the above-mentioned operations, for example, installing a news application to browse news; or users can also use browser-type applications of a terminal to achieve the above-mentioned operations, for example, browsing news, viewing the weather, communicating with other users, and so on.

For example, when a user receives pushed news, if he/she wants to browse the news, then the user needs to click the news and enter the corresponding application (news application or browser application), and after completion of the browsing, the user needs to exit the application, which results in complicated operations.

### SUMMARY

The objective of embodiments of the present application is to provide a method and device for displaying information as well as a terminal equipment, so as to make the operation simple.

In order to achieve the above objective, embodiments of the present application disclose a method for displaying information, which comprises steps of:

receiving a display instruction and displaying at least one information card on a display screen of a terminal equipment;

receiving a switching instruction;

if the switching instruction is to slide rightwards, at least one new information card is moved into the display screen from left to right when moving the at least one information card rightwards out of the display screen;

if the switching instruction is to slide leftwards, at least one new information card is moved into the display screen from right to left when moving the at least one information card leftwards out of the display screen;

wherein the size of the information card is smaller than the size of the display screen, and the information card includes information to be displayed.

In order to achieve the above objective, embodiments of the present application further disclose a device for displaying information, which comprises:

a first display module for receiving a display instruction and displaying at least one information card on a display screen of a terminal equipment, wherein the size of the information card is smaller than the size of the display screen, and the information card includes information to be displayed;

a switching module for receiving a switching instruction; if the switching instruction is to slide rightwards, at least one new information card is moved into the display screen from left to right when moving the at least one information card rightwards out of the display screen; if the switching instruction is to slide leftwards, at least one new information card is moved into the display screen from right to left when moving the at least one information card leftwards out of the display screen.

In order to achieve the above objective, embodiments of the present application further disclose a terminal equipment, which comprising: a processor, a memory, communication interfaces, input/output interfaces and a bus. Wherein the processor, the memory, the communication interfaces and the input/output interfaces are connected to the bus respectively, the memory is used for storing executable program codes; the processor executes a program corresponding to the executable program codes through reading the executable program codes stored in the memory, so as to perform the following steps:

receiving a display instruction and displaying at least one information card on a display screen of the terminal equipment;

receiving a switching instruction;

if the switching instruction is to slide rightwards, at least one new information card is moved into the display screen from left to right when moving the at least one information card rightwards out of the display screen;

if the switching instruction is to slide leftwards, at least one new information card is moved into the display screen from right to left when moving the at least one information card leftwards out of the display screen;

wherein, the size of the information card is smaller than the size of the display screen, and the information card includes information to be displayed.

In order to achieve the above objective, embodiments of the present application further disclose an application program, which is used to perform the method for displaying information mentioned above when being executed.

In order to achieve the above objective, embodiments of the present application further disclose a storage medium for storing application programs, which application programs are used to perform the method for displaying information mentioned above when being executed.

By applying the embodiments of the present application, at least one information card is displayed on a display screen of a terminal equipment after a display instruction is received, the information card including information to be displayed. That is, an information card is displayed as long as a terminal equipment receives a display instruction, such that a user can browse information displayed on the information card without entering an application, and thus the operation is simple. In addition, the terminal device can also switch information cards after receiving a switching instruction to display more information to a user.

Of course, the implementation of any of the products or method of the present application is not necessary to achieve all the advantages described above at the same time.

### BRIEF DESCRIPTION OF THE DRAWINGS

In order to describe the embodiments of the present application and the technical solutions in the prior art more clearly, drawings required for embodiments of the present application and the prior art will be described briefly below. It is obvious that the drawings below only show some embodiments of the present application, and those skilled in the art can also obtain further drawings based on these drawings without any creative efforts.

FIG. 1 is a first schematic flowchart of the method for displaying information provided by an embodiment of the present application;

FIGS. 2a-2d are schematic views of interfaces of the information display interfaces provided by embodiment of the present application;

FIGS. 2e-2m are line drawings of interfaces of the information display interfaces provided by embodiments of the present application;

FIG. 3 is a second schematic flowchart of the method for displaying information provided by an embodiment of the present application;

FIG. 4 is a schematic structural diagram of a device for displaying information provided by an embodiment of the present application;

FIG. 5 is a schematic structural diagram of a terminal equipment provided by an embodiment of the present application.

### DETAILED DESCRIPTION

In order to make the objections, technical solutions as well as advantages of the present application more apparent and understandable, the present application will be described in more detail below with reference to the appended drawings and embodiments. Obviously, the described embodiments are only some of the embodiments of the present application, rather than all of the embodiments. All other embodiments obtained based on the embodiments of the present application by those skilled in the art without doing any creative work fall into the protection scope defined by the present application.

In order to solve the above technical problem, embodiments of the present application provide a method and device for displaying information as well as a terminal equipment. The method and device can be applied to various terminal devices such as mobile phones, tablets and the like.

First, a method for displaying information provided by the embodiments of the present application will be described in detail below.

FIG. 1 is a first schematic flowchart of the method for displaying information provided by an embodiment of the present application, which comprises:

S101: receiving a display instruction and displaying at least one information card on a display screen of a terminal equipment, wherein the size of the information card is smaller than the size of the display screen, the information card includes information to be displayed.

In the present embodiment, there may be many cases in which a display instruction is received by a terminal equipment. For example, when it is detected by a terminal equipment that a display screen becomes bright, that is, when a display screen is switched from a screen-off state to a screen-on state, it can be considered that a display instruction is received. Or a terminal equipment initiates a timer, each time the timer reaches a preset period, it can be considered that a display instruction is received. Or when a terminal equipment receives a push information or a prompt message from a third-party application or the system, it can be considered that a display instruction is received, and so on.

For ease of description, the information to be displayed, which is contained in an information card, is here referred to as target information.

As an embodiment, a terminal equipment may obtain target information in advance and display the target information after receiving a display instruction. For example, the target information is information for informative purpose, the target information for informative purpose can be obtained from applications for informative purpose or from Internet when the display screen of a terminal equipment is in a screen-off state, and when it is detected that the display screen is switched to a screen-on state, an information card is displayed on the display screen, which information card contains the target information for informative purpose.

As another embodiment, target information may be obtained in real time and displayed after a display instruction is received. For example, when a terminal equipment receives push information or a prompt message from a third-party application or the system, the terminal equipment obtains the push information or the prompt message in real time, and generates target information based on the push information or the prompt message and display the target information.

For example, upon receiving a chat message from a friend sent via WeChat application, target information can be generated based on the friend's identity and the chat content.

Upon receiving a power prompt message or a memory prompt message sent by the system, target information can be generated based on the prompt message.

As another embodiment, the display instruction may also be a display instruction input by a user, in which case the information to be displayed in an information card includes information obtained from network side according to the display instruction input by the user.

That is, it is possible to obtain corresponding target information from network side according to a display instruction input by a user and to display the target information on a display screen of a terminal equipment in form of an information card. Or it is also possible to obtain some information from network side in advance, and to determine the target information corresponding to a display instruction input by a user among the information obtained in advance after receiving the display instruction, and then to display the target information on the display screen of the terminal equipment in form of an information card.

For example, some controls can be set in display cards, such as a control to get weather information by a click. The terminal equipment can obtain weather information in advance from network side, and display the weather information on an information card after detecting that the control is clicked by a user, that is, after receiving a display instruction input by a user.

For example, some search entries can be set in display cards. A user can enter a keyword in the search entries. The terminal can obtain target information corresponding to the keyword from network side, and display the target information on an information card after detecting the keyword input by a user, that is, after receiving a display instruction input by a user.

As an embodiment, an information card can include a multimedia resource display area and/or a text area, wherein the multimedia resource display area is used for displaying multimedia resource information, and the text area is used for displaying text information.

The multimedia resource information can include pictures, videos and the like. If the information card includes information for informative purpose, the multimedia resource display area can display the pictures related to the information for informative purpose while the text area can display the summary content of the information for informative purpose. If the information card includes a chat message from a friend sent via WeChat application, the multimedia resource display area can display the avatar of the friend, background pictures and the like while the text area can display chat contents.

When the information card includes both the multimedia resource display area and the text area, the two areas can be arranged vertically or horizontally, which is not specifically limited.

If a plurality of pieces of target information are obtained, the information to be displayed in the current information card can be determined among the obtained target information, which is referred to as the current target information. The current target information can be interpreted as the target information to be displayed to users in the first place. When determining the current target information, the content in which the user is interested can be preferentially determined as the current target information based on user's preferences; or important information, such as prompt message from the system and the like, can also be determined as the current target information such that the user will handle the important information with priorities; or the target information with the highest relevancy to the display instruction input by a user can also be determined as the current target information.

That is, priority rules can be set according to actual situations and then the current target information can be determined according to the priority rules. The information card, which contains the above determined current target information, is displayed after receiving a display instruction.

As an embodiment, an information card can be displayed in a locked-screen state when it is detected that the display screen becomes bright.

As another embodiment, an information card can be displayed in the current desktop, or in the current application.

In other words, the present method can be used in a variety of application scenarios. For example, the terminal equipment detects that the display screen becomes bright (a display instruction is received) in a locked-screen state, in this case an information card can be displayed. Or the interface of an application is currently being displayed by the terminal equipment and then push information of a third-party application is received (a display instruction is received), in this case an information card can be displayed in the current application. Or the desktop is currently displayed by the terminal equipment and then push information from a third-party application is received (a display instruction is received), in this case an information card can be displayed on the current desktop.

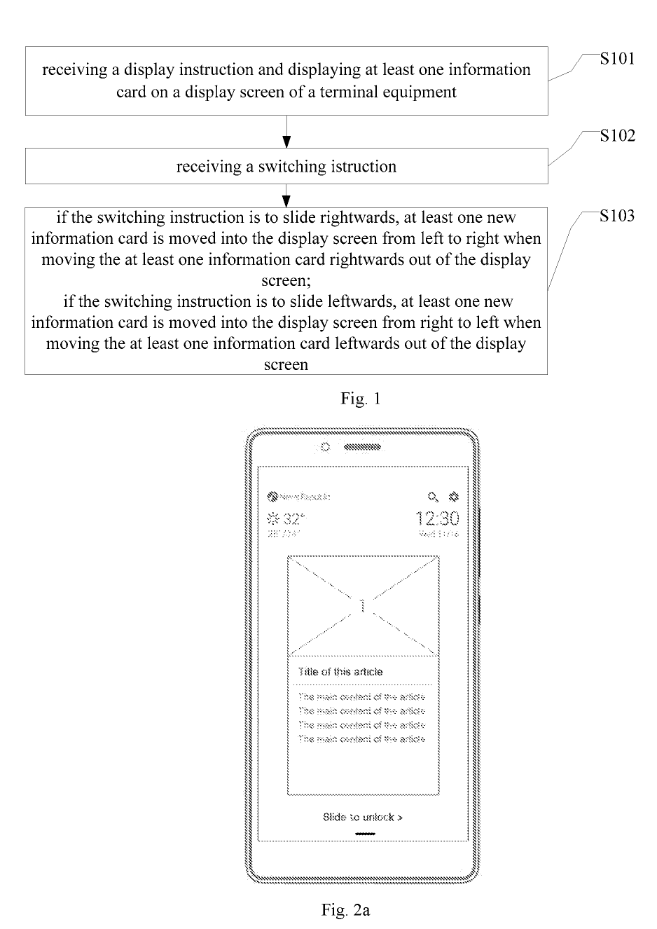

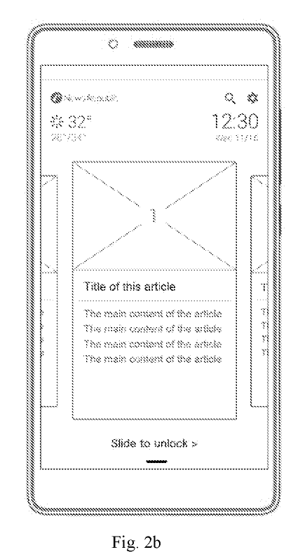

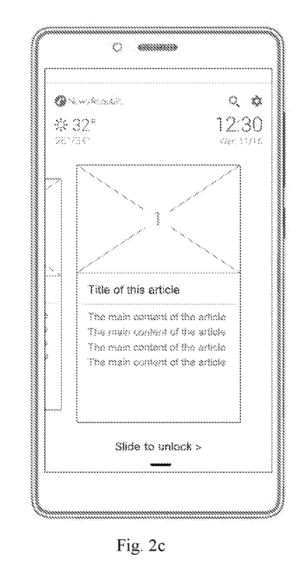

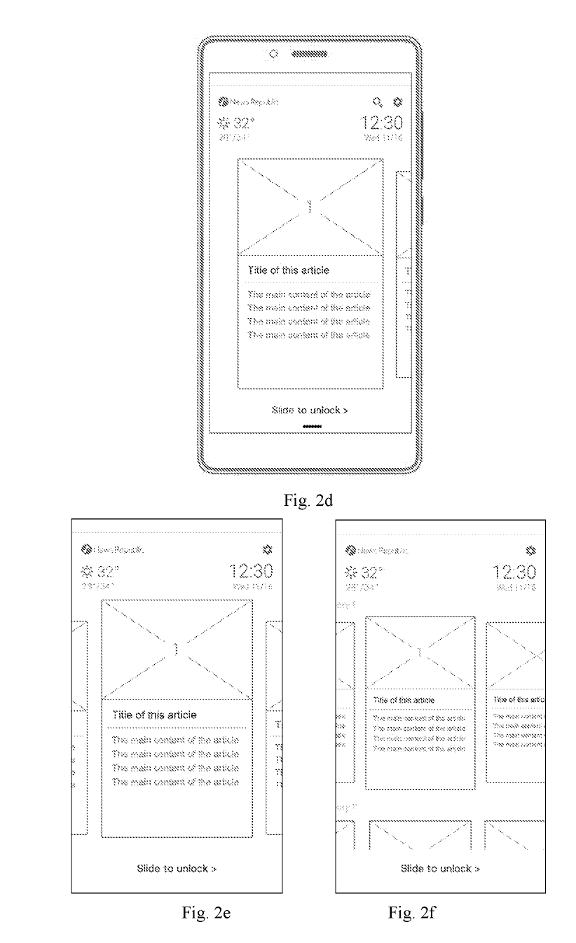

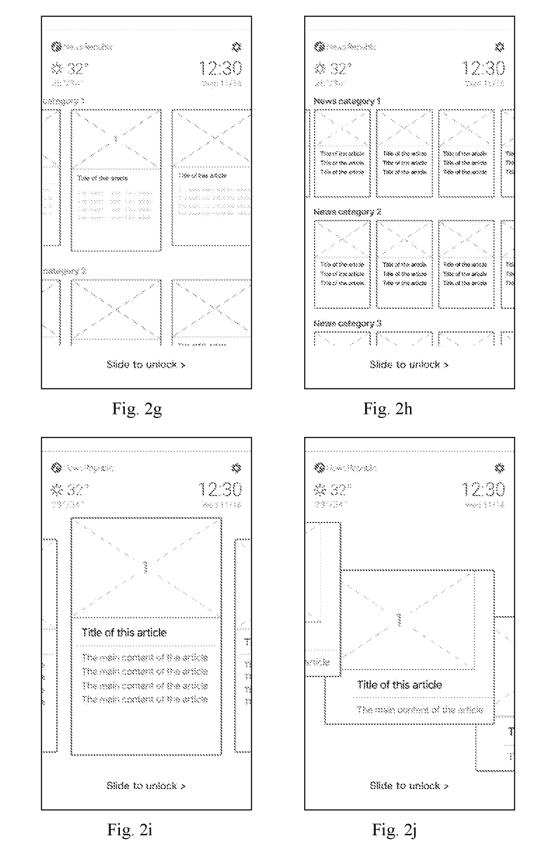

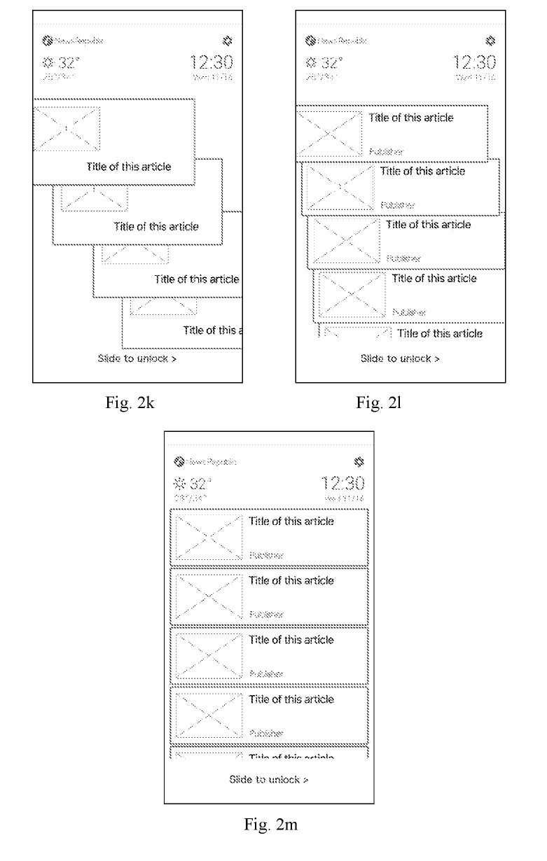

The above information card can be interpreted as a combined carrier for information control and information display, which provides an interface for information control and information display. Specifically, the above information card can be used only for information display, and can also be used for both information display and information input, which is not limited by the present application. The information card can be a rectangle of a preset size or other shape, wherein the size and shape of the information card can be set according to the display screen of a terminal equipment. It should be noted that the size of the information card is smaller than that of the display screen. As shown in FIG. 2a, the information card does not cover the entire display screen. This information card can be referred to as a large card.

As an embodiment, prompt information can be displayed in a preset position on the display screen, the prompt information being used for prompting the presence of other information cards.

That is, when multiple pieces of target information are obtained and multiple information cards are present, prompt information can be displayed in a preset position on the display screen, to remind the user that there are further multiple pieces of browsable target information.

Specifically, the prompt information can be a prompt symbol of arrow shape or a prompt card in a card form. The prompt card can be a card with a size smaller than that of the information card, for example, a card with a width narrower than that of the information card and/or a card with a height smaller than that of the information card. The prompt card can display partial content of the target information, or does not display the content of the target information, both situations can play a role in prompting the user.

As an embodiment, a prompt card can be displayed at the left boundary and/or the right boundary of the display screen, wherein the size of the prompt card is set according to the remaining size of the display screen, which remaining size is the size obtained by subtracting the size of the information card from the size of the display screen.

As shown in FIG. 2b, prompt cards can be displayed at both the left boundary and the right boundary of the display screen, and a prompt card can be displayed only at the left boundary of the display screen as shown in FIG. 2c, and a prompt card can also be displayed only at the right boundary of the display screen as shown in FIG. 2d, which is not limited specifically.

After browsing the information card currently being displayed, a user can slide the display screen leftward or rightward to browse other information cards.

S102: receiving a switching instruction.

S103: if the switching instruction is to slide rightwards, at least one new information card is moved into the display screen from left to right when moving the at least one information card rightwards out of the display screen; if the switching instruction is to slide leftwards, at least one new information card is moved into the display screen from right to left when moving the at least one information card leftwards out of the display screen.

It should be noted that there can be several ways to switch from the information card previously displayed to a new information card. For example, the new information card can replace the previous card directly in a preset switching manner; or the new information card can replace the previous information card in a built-in switching manner.

The above preset switching manner can be the manner to display the target information after the switch directly, to display the target information after the switch in an explosive manner, to display the target information after the switch in a slowly-moving manner from top to bottom and the like.

The above built-in switching manner can be to slide inward linearly, to slide inward according to a preset curve line, to fly inward and the like.

The present embodiment provides a switching manner, i.e. sliding leftward or rightward to switch, that is to say, a correlated movement of the information card previously displayed and a new information card, while the information card previously displayed is moved out of the display screen, the new information card is moved into the display screen.

Specifically, if the switching instruction is to slide rightwards, the new information card is moved into the display screen from left to right when the information card previously displayed is moved rightward out of the display screen; if the switching instruction is to slide leftwards, the new information card is moved into the display screen from right to left when the previously displayed information card is moved leftward out of the display screen.

It should be noted that the switching instruction can be a received switching instruction input by a user, or can also be a received switching instruction generated according to a predefined rule.

It can be understood that a user can slide leftwards or rightwards on the display screen. It can indicates that a switching instruction is received if an operation of sliding leftwards or rightwards by a user is detected. If the operation is that the user slides leftward, then the switching instruction is to slide leftward, and if the operation is that the user slides rightward, then the switching instruction is to slide rightward.

Or a predefined rule can be set. For example, a switching instruction is received to switch the information card after the information card has been already displayed for a preset duration. Specifically, a timer can be started in the information card which displays information, it is considered as that the switching instruction is received when the timer gets to the set duration, in which case the information card is switched.

Since the switching instruction comprises sliding leftwards and rightwards, correspondingly, the information card can be displayed in the manner that at least one information card is arranged horizontally on the display screen. It can be understood that sliding leftward and rightward conforms to the usage habit of users when the information card is arranged horizontally.

Generally, if the terminal equipment is a cell phone, the display screen thereof is smaller and can display only one information card; if the terminal equipment is a tablet, the display screen thereof is larger and can display more information cards. Each information card can be displayed in horizontal arrangement on the display screen when the number of the information cards is greater than 1. Or each information card can be arranged according to the size of the actual terminal.

By applying the embodiment of the application shown in FIG. 1, at least one information card is displayed on a display screen after a display instruction is received, the information card including the information to be displayed. There may be many cases in which a display instruction is received by a terminal equipment: when it is detected by a terminal equipment that a display screen becomes bright; or a terminal equipment initiates a timer and each time the timer reaches a preset period; or when a terminal equipment receives a push information or a prompt message from a third-party application or a system, and the like, in which cases a display instruction can be considered received. An information card is displayed as long as a terminal equipment receives a display instruction, such that a user can browse information displayed on an information card without entering an application, and thus the operation is simple. In addition, the terminal device can also switch information cards after receiving a switching instruction to display more information to a user.

In the embodiment shown in the present application, a user may not only view the information card but also perform other operations thereon such as zooming in, zooming out, deleting, flipping over, etc.

As an embodiment, a first interaction instruction for the information card can be received and an operation corresponding to the first interaction instruction can be performed.

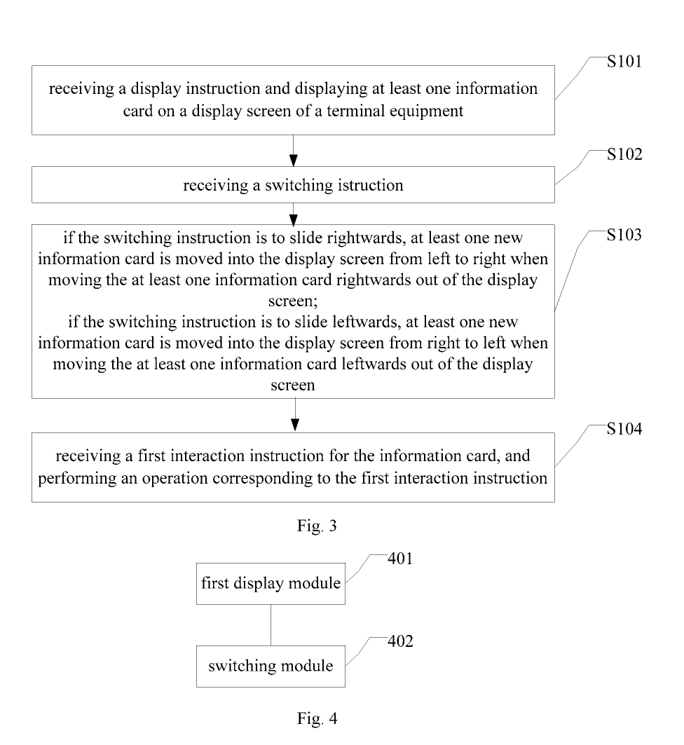

As the embodiment shown in FIG. 3, which is a second flowchart of the method for displaying information provided by an embodiment of the present application. After S101, the following steps are performed:

S104: receiving a first interaction instruction for the information card and performing an operation corresponding to the first interaction instruction.

As an embodiment, the first interaction instruction can be an instruction of moving out a card. The step of performing an operation corresponding to the first interaction instruction can comprise moving the information card upwards or downwards out of the display screen.

A delete button can be set in the information card, and it indicates that the instruction of moving out a card is received if it is detected that the user clicks the delete button. Or the instruction of moving out a card can be a preset gesture of users, and it indicates that the card instruction of moving out a card is received if the preset gesture of users is detected.

If only one information card is currently displayed on the display screen, the information card can be directly moved upwards or downwards out of the display screen. If several information cards are currently displayed on the display screen, the information card to be deleted, to which the instruction of moving out a card corresponds, can be determined and then the determined information card to be deleted is moved upwards or downwards out of the display screen.

It should be noted that if a user moves the information card out of the display screen, it indicates that the user is not interest in the information displayed in the information card. Thus, this kind of information can be marked, and then, upon displaying information cards, this kind of information card can be deleted or is not generated any more.

By applying the embodiment, the information card can be moved out of the display screen according to the instruction of users, and thereby the kind of information in which users are not interested is recorded, to avoid displaying this kind of information card again during the subsequent process of displaying information, thus improving user experience.

As an embodiment, the first interaction instruction can be an instruction of flipping over a card. The step of performing an operation corresponding to the first interaction instruction can comprise:

flipping over the information card and displaying related information of the information to be displayed, which is contained in the information card, on the back of the information card.

A flipping-over button can be set in the information card, and it indicates that the instruction of flipping over a card is received if it is detected that a user clicks the flipping-over button. Or the instruction of flipping over a card can be a preset gesture of users, and it indicates that the instruction of flipping over a card is received if the preset gesture of users is detected.

It is the back of the information card that is displayed after the information card is flipped over. The information contained on the back of the information card can be associated with the information contained on the front thereof.

For example, if the information contained on the front of the information card is information for informative purpose, then the information contained on the back of the information card can be comment information associated with the information for informative purpose, information for informative purpose associated with the information for informative purpose, or advertisement and the like, which is not limited specifically.

If the information contained on the front of the information card is a message from a friend sent via WeChat application program, the information contained on the back thereof can be the identity information of said friend.

According to the above description, an information card can contain a multimedia resource display area and a text area, the multimedia resource display area being used for displaying multimedia resource information and the text area being used for displaying text information. In this case, when the information card is flipped over, it is possible to only flip over the text area while the multimedia resource display area is not flipped over. The text information related to the text information of the text area is displayed on the back of the information card.

For example, the information card contains information for informative purpose, the multimedia resource display area displays related pictures of the information for informative purpose, the text area displays the summary content of the information for informative purpose, and the text area on the back of the information card displays the comment information for the information for informative purpose. When the information card is flipped over, only the text area is flipped, whereas the multimedia resource display area remains the same, such that users can see pictures when browsing comment information, and thus the design is more reasonable.

By applying the embodiment of the application, more information can be displayed on the back of the information card through flipping over the information card; on the other hand, user experience is better through adding the function of flipping over a card.

As an embodiment, the first interaction instruction can be an instruction of adjusting card size. The step of performing an operation corresponding to the first interaction instruction can comprise:

adjusting the size of an information card on the display screen.

A size-enlarging button, a size-reducing button and the like can be set in the information card, or a corresponding relationship between a gesture of a user and an instruction can be preset. For example, it denotes the size-reducing instruction if a user conducts a pinch-in gesture, and it denotes the size-enlarging instruction if a user conducts a pinch-out gesture, which is not limited specifically.

It can be regarded as that an instruction of adjusting card size is received when it is detected that a user clicks the size-enlarging button in the information card or the pinch-out gesture of a user is detected. In this case, the size of information card can be enlarged, and correspondingly, characters and pictures contained in the information card can also be enlarged in the same proportion.

Similarly, it can be regarded as that an instruction of adjusting card size is received when it is detected that a user clicks the size-reducing button in the information card or the pinch-out gesture by a user is detected. In this case, the size of information card can be reduced, and correspondingly, the size of characters and pictures contained in the information card can also be reduced in the same proportion.

As an embodiment, the first interaction instruction is an instruction of adjusting the number of cards. The step of performing an operation corresponding to the first interaction instruction can comprise:

adjusting the number of the information cards on the display screen.

A button of “number of cards” or other similar buttons can be set in the information card or in other position on the display screen, such that users can adjust the number of information cards on the display screen through the button.

According to the above description, the number of information cards can be greater than 1. In this case, users can further rearrange the several information cards.

Specifically, a user can click the rearrangement button in the information card and choose the information card to be rearranged and the position after rearrangement. Or the user can use a preset gesture on the display screen to arrange the information cards. In both cases, the terminal equipment can rearrange each of the displayed information card according to the arrangement information (the information card to be arranged and the position thereof after rearrangement) carried in an arrangement request.

As an embodiment, the first interaction instruction can be an instruction of adjusting information state. The step of performing an operation corresponding to the first interaction instruction can comprise:

adjusting the display state of information in the information card.

The display state of the information in the above information card can comprise the size of characters and pictures of the information displayed in the information card, or can comprise a folded display or an unfolded display of the displayed content.

In the present embodiment, characters and pictures in the information card can be zoomed in without changing the size of information card.

In the present embodiment, a zooming-in button, a zooming-out button and the like can be set in the information card, or a corresponding relationship between a gesture of a user and an instruction can be set in advance. For example, it denotes a zooming-in instruction if a user conducts a pinch-in gesture, and it denotes a zooming-out instruction if a user conducts a pinch-out gesture, which is not limited specifically.

It can be regard as that the instruction of adjusting information state is received when it is detected that a user clicks the zooming-in button in the information card or the pinch-in gesture of a user is detected. In both cases, the enlarged current target information can be determined and displayed.

Since in the present embodiment, the size of an information card remains the same and the content arrangement displayed in the information card is to vary after texts and pictures in the information card are zoomed in, the current target information after zoomed in can be re-determined and displayed.

For example, if the font size after zoomed in is 10 pt, it is determined that the number of words which can be displayed in the information card is 100, and then the 100 words are displayed in an arrangement.

Similarly, it can be regarded as that an instruction of adjusting information state sent by a user is received when it is detected that the user clicks the zooming-out button in the information card or a pinch-out gesture of a user is detected. In both cases, the current target information after zoomed out can be determined and displayed.

Since in the present embodiment, the size of an information card remains the same and the content arrangement displayed in the information card is to vary after texts and pictures in the information card are zoomed out, the current target information after zoomed out can be re-determined and displayed.

For example, if the font size before zoomed out is 8 pt and the number of words which can be displayed in the information card is 200, the font size after zoomed out is 6 pt and the number of words which can be displayed in the information card is 400, and then target information can be re-obtained. The re-obtained target information content can be more than previous target information, and the information card is re-generated according to the re-obtained target information, wherein the regenerated main card can contain 400 words.

In the present embodiment, an “unfold the content” button and a “fold” button or other similar buttons can be set in the information card, such that a user can adjust the display state of an information card on the display screen through said button.

For example, if the information contained in an information card is a prompt message sent by WeChat application program, which prompt message carries friend circle information published by a friend and the friend circle information contains a lot of content, then the display state can be divided as a folded display and an unfolded display. A user can browse the complete content of the friend circle information through the “unfold the content” button when the friend circle information is folded-displayed; and a user can switch the display state of the friend circle information to a folded display through the “fold” button when the friend circle information is unfolded-displayed.

By applying the above embodiment, the information card can be enlarged or reduced, and each information card can also be adjusted regarding the number thereof or be rearranged, and the information in information cards can also be adjusted, such that the user experience is improved.

As an embodiment, the first interaction instruction can be an instruction of displaying related information. The step of performing an operation corresponding to the first interaction instruction can comprise:

displaying information related to the information card in a new window of the display screen.

For example, the information displayed in an information card is target information for informative purpose, which only contains pictures and the summary of texts, a “read more” prompt button and the like can be set in the information card. After a user clicks said prompt button (receiving an instruction of displaying related information), the corresponding application program interface appears (a new window on the display), i.e. an interface of an application program for informative purpose, such that the user can browse more information for informative purpose.

As an embodiment, a second interaction instruction can be also received, the second interaction instruction being an instruction for a new window of the display screen; the information corresponding to the second interaction instruction is displayed.

As an extension of the above example, after jumping to the interface of an application program for informative purpose, the interaction instruction for the application program interface can be further received. For example, after the instruction of displaying other information for informative purpose in the application program interface is received, other information for informative purpose corresponding to said instruction is displayed.

By applying the above embodiment, a user can browse more information by card jumping to a new interface, thereby improving the ease of a user's operation.

As an embodiment, the first interaction instruction can be a layout adjusting instruction. The step of performing an operation corresponding to the first interaction instruction can comprise:

obtaining at least two summary cards to be displayed, and replacing the information card currently being displayed with the at least two summary cards, wherein, the summary card is the above information card of a reduced size, in which the summary content of the target information can be displayed. The summary content of each piece of target information can be the entire target information, or can be a part of the target information, which is not limited by the present application.

Specifically, according to several pieces of target information obtained by a terminal equipment, the summary content of these several pieces of target information is displayed in several summary cards correspondingly. In each summary card, the summary content of one piece of target information is displayed, in which the information can be displayed in a zoomed-out manner, or can be displayed according to a preset interface layout manner. For example, pictures and texts are displayed on the left side and right side of a summary card respectively.

In an embodiment of the application, the at least two summary cards can be arranged in a spaced manner. In this case, these summary cards can be uniformly arranged in an equally spaced manner or can also be non-uniformly arranged in an unequally spaced manner, which is not limited by the application herein.

It can be understood by those skilled in the art that target information obtained by a terminal equipment can belong to different types of information according to different classification perspectives. For example, if the target information is information for informative purpose obtained from network side, then the target information can be classified according to a perspective of information for informative purpose, such as sports information, entertainment information, news information and the like; if the target information is obtained form a third-party application or from the system, then the target information can be classified with application identifiers, such as WeChat, system information and the like. Based on this, when the above at least two summary cards are uniformly arranged in the equally spaced manner, the summary cards can form a summary card row when viewed horizontally and the summary cards can form a summary card column when viewed vertically. On this basis, one row or one column of summary cards can correspond to one type of information, such that a user can find the summary card corresponding to the desired application program according to the classification easily.

Specifically, the maximum number of the summary cards contained in each summary card row and/or each summary card column displayed on the display screen can be preset, for example, 3, 4, 5 and the like.

Assume that one row of summary cards corresponds to one type of information and the preset maximum number of the summary cards contained in one row of summary cards displayed on the display screen is: 4.

If the type of information is classified according to application identifiers, then the number of summary cards corresponding to each type of information and the number of summary cards in the summary card row displayed on the display screen are as follows respectively:

the number of summary cards corresponding to system information is: 4, and the number of the summary cards displayed in the row is 4;

the number of summary cards corresponding to WeChat is: 3, and the number of summary cards displayed in the row is 3.

If the type of information is classified according to a perspective of information for informative purpose, then the number of summary cards corresponding to each type of information and the number of summary cards in the summary card row displayed on the display screen are as follows respectively:

the number of summary cards corresponding to sports information is: 4, and the number of summary cards displayed in the row is 4;

the number of summary cards corresponding to entertainment information is: 3, and the number of summary cards displayed in the row is 3;

the number of summary cards corresponding to news information is: 2, and the number of summary cards displayed in the row is 2.

It can be seen from the above that the number of the summary cards displayed in each row will be less than or equal to the preset maximum number of the summary cards contained in a row.

Moreover, an information type identifier can be displayed in a preset position when one row or one column of summary cards corresponds to one type of information. For example, the information type identifier is displayed in the upper left corner of a row of summary cards, or the information type identifier is displayed in the top end of a column of summary cards, etc.

Specifically, see FIGS. 2e-2h, which show the process of at least two summary cards replacing the information card currently being displayed in line drawings of interfaces. As can be seen from the four line drawings, after a layout adjusting instruction is received, the size of the information card currently being displayed is reduced gradually and finally the information card currently being displayed becomes the summary card to which it corresponds, while other summary cards gradually enter the display screen, and finally the summary card of the information card currently being displayed is displayed along with other summary cards. It should be noted that the process shown in FIGS. 2e-2h is only the case that the information card currently being displayed is replaced with at least two summary cards, and the specific realization form of the replacement process is not limited by the application.

In another embodiment of the application, the at least two summary cards can be displayed in at least one column as a summary card queue, wherein summary cards in the summary card queue are arranged in a non-overlapping manner;

the above at least two summary cards can also be displayed in at least one row as a summary card queue.

Specifically, the summary card queue contains at least one summary card. Each summary card in a same summary card queue can be equally spaced arranged in a non-overlapping manner or can also be non-equally spaced arranged in a non-overlapping manner.

Specifically, see FIGS. 2i-2m, which show the process of at least two summary cards replacing the information card currently being displayed in line drawings of interfaces. As seen from the five line drawings, after a layout adjusting instruction is received, the information card currently being displayed in a horizontal arrangement gradually becomes a summary card, and then becomes summary cards vertically arranged in an overlapping manner. The size of the summary cards are gradually reduced in the process of overlapping transformation and the information cards not being currently displayed gradually enter the display screen.

By comparing FIGS. 2i and 2m, it can be seen that the content of the summary cards is only a part of the content in the information card and the arrangement of the images and text in the summary card is changed with respect to the arrangement of the images and text in the information card, which is changed from a vertical arrangement to a horizontal arrangement.

It should be noted that the process shown in FIGS. 2i-2m is only the case that the information card currently being displayed is replaced with at least two summary cards, and the specific realization form of the replacement process is not limited by the application.

The process in which the display of an information card is changed to the display of summary cards after receiving a layout adjusting instruction (which is referred to as the first layout adjusting instruction below) is described above. Specifically, the display of summary cards can also be changed to the display of an information card through receiving another layout adjusting instruction (which is referred to as the second layout adjusting instruction below). Optionally, when the display of summary cards is changed to the display of an information card, the information card displayed can be the one before changed to the display of summary cards, or it can be the information card corresponding to the summary card newly selected by a user, which is not limited by the application.

When changing the layout, the above first layout adjusting instruction can be an instruction generated through detecting a pinch-out gesture. In this case, after the display of summary cards is changed to the display of an information card, the displayed information card contains the information card displayed before the summary cards are displayed. Moreover, the above second adjusting instruction can be an instruction generated through detecting that a user clicks a summary card. In this case, after the display of summary cards is changed to the display of an information card, the displayed information card contains the information card corresponding to the summary card clicked by the user.

Corresponding to the above embodiments of method, the application further provides a device for displaying information.

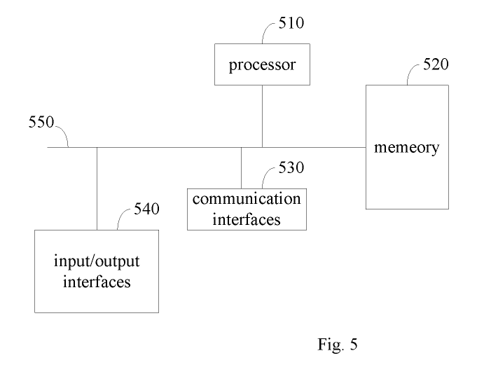

FIG. 4 is a structural diagram of a device for displaying information provided by an embodiment of the application, which comprises:

a first display module 401 for receiving a display instruction and displaying at least one information card on a display screen of a terminal equipment, wherein the size of information card is smaller than the size of the display screen, and the information card includes information to be displayed;

a switching module 402 for receiving a switching instruction; if the switching instruction is to slide rightwards, at least one new information card is moved into the display screen from left to right when moving the at least one information card rightwards out of the display screen; if the switching instruction is to slide leftwards, at least one new information card is moved into the display screen from right to left when moving the at least one information card leftwards out of the display screen.

In the present embodiment, the first display module can be specifically used for:

receiving a display instruction input by a user and displaying at least one information card on a display screen of a terminal equipment;

wherein the information to be displayed includes information obtained from the network side according to the display instruction input by the user.

In the present embodiment, the device can further comprise:

a second display module (not shown in the figures) for displaying prompt information in a preset position on the display screen, the prompt information being used for prompting the presence of other information cards.

In the present embodiment, the second display module can be specifically used for:

displaying a prompt card at the left boundary and/or the right boundary of the display screen, wherein the size of the prompt card is set according to the remaining size of the display screen, the remaining size being the size obtained by subtracting the size of the information card from the size of the display screen.

In the present embodiment, the switching instruction can be a switching instruction input by a user or generated according to a predefined rule.

In the present embodiment, the first display module 401 can be specifically used for:

receiving a display instruction and displaying the information card on a display screen of a terminal equipment in a manner in which at least one information card is arranged horizontally.

In the present embodiment, the information card comprises a multimedia resource display area and/or a text area, wherein the multimedia resource display area is used for displaying multimedia resource information, and the text area is used for displaying text information.

In the present embodiment, the device can further comprise a first receiving module and a performing module (not shown in the figures), wherein;

the first receiving module is used for receiving a first interaction instruction for the information card;

the performing module is used for performing an operation corresponding to the first interaction instruction.

In the present embodiment, the first interaction instruction is an instruction of moving out a card, the performing module is specifically used for:

moving the information card upward or downward out of the display screen;

or the first interaction instruction is an instruction of flipping over a card, the performing module is specifically used for:

flipping over the information card and displaying related information of the information to be displayed, which is included in the information card, on the back of the information card.

In the present embodiment, when the information card comprises a multimedia resource display area and a text area, and the first interaction instruction is an instruction of flipping over a card, the performing module is specifically used for:

flipping over the text area of the information card to the back of the information card and displaying related text information of the text information of the text area on the back of the information card.

In the present embodiment, the first interaction instruction is an instruction of adjusting card size, the performing module is specifically used for:

adjusting the size of the information card on the display screen;

or the first interaction instruction is an instruction of adjusting the number of cards, the performing module is specifically used for:

adjusting the number of the information cards displayed on the display screen;

or the first interaction instruction is an instruction of adjusting information state, the performing module is specifically used for:

adjusting the display state of information in the information card.

In the present embodiment, the first interaction instruction is an instruction of displaying related information, the performing module is specifically used for:

displaying information related to the information card in a new window of the display screen.

In the present embodiment, the device can further comprise a second receiving module and a third display module (not shown in the figures), wherein,

the second receiving module is used for receiving a second interaction instruction, the second interaction instruction being an instruction for the new window of the display screen;

the third display module is used for displaying information corresponding to the second interaction instruction.

In the present embodiment, the first interaction instruction is a layout adjusting instruction, the performing module can be specifically used for:

obtaining at least two summary cards to be displayed, wherein the content of each summary card is determined according to the information obtained from a program of the terminal equipment, the at least two summary cards comprise a summary card of the information card currently being displayed;

replacing the information card currently being displayed with the at least two summary cards.

In the present embodiment, the at least two summary cards are arranged in a spaced manner.

In the present embodiment, the at least two summary cards are uniformly arranged in an equally spaced manner;

one row or one column of summary cards corresponds to one type of information.

In the present embodiment, the at least two summary cards are displayed in at least one column as a summary card queue, wherein summary cards in the summary card queue are arranged in a non-overlapping manner; or

the at least two summary cards are displayed in at least one row as a summary card queue.

By applying the embodiments of the present application shown in FIG. 4, at least one information card is displayed on a display screen of a terminal equipment after a display instruction is received. It means that an information card is displayed as long as a terminal equipment receives a display instruction, so that a user can browse information displayed on an information card without entering an application, and thus the operation is simple. In addition, the terminal device can also switch information cards after receiving a switching instruction to display more information to a user.

An embodiment of the application further provides a terminal equipment. As shown in FIG. 5, the terminal comprises: a processor 510, a memory 520, communication interfaces 530, input/output interfaces 540 and a bus 550, wherein the processor 510, the memory 520, the communication interfaces 530 and the input/output interfaces 540 are connected to the bus 550 respectively, the memory 520 being used for storing executable program codes; the processor 510 executing a program corresponding to the executable program codes through reading the executable program codes stored in the memory 520, so as to perform the following steps:

receiving a display instruction and displaying at least one information card on a display screen of a terminal equipment;

receiving a switching instruction;

if the switching instruction is to slide rightwards, at least one new information card is moved into the display screen from left to right when moving the at least one information card rightwards out of the display screen;

if the switching instruction is to slide leftwards, at least one new information card is moved into the display screen from right to left when moving the at least one information card leftwards out of the display screen;

wherein, the size of the information card is smaller than the size of the display screen, the information card includes information to be displayed.

Regarding the specific process of the processor 510 performing the above steps and the steps further performed by the processor 510 through operating executable program code, reference can be made to the related description of the method provided by embodiments of the present application, which will not be repeated here.

Wherein the display screen acts as the input interface and the output interface when the display screen of the terminal equipment is a touch screen; and the display screen acts as the output interface with a keyboard and/or a mouse as the input interface when the display screen of the terminal equipment is not a touch screen.

The terminal equipment is present in a variety of forms, which comprise but do not be limited to:

(1) mobile communication equipment: this kind of equipment is characterized in the ability of mobile communication and mainly aims to provide voice and data communication. This kind of terminal comprises: smartphones (for example, iPhone), multimedia phones, functional phones and low end phones and the like.

(2) ultra-mobile personal computer equipment: this kind of equipment belongs to the category of personal computer, which has the function of computing and possessing and generally possesses mobile networking property. This kind of terminal comprises: PDA, MID and UMPC equipment and the like, for example iPad.

(3) portable entertainment equipment: this kind of equipment can display and play multimedia content. This kind of equipment comprises: audio and video players (for example, iPods), handheld game consoles, e-books readers, intelligent toys and portable vehicle navigation equipment.

(4) other electric device with data interaction function.

As shown above, in the embodiments of the present application, at least one information card is displayed on a display screen of a terminal equipment after a display instruction is received, the information card including information to be displayed. That is, an information card is displayed as long as a terminal equipment receives a display instruction, such that a user can browse information displayed on the information card without entering an application, and thus the operation is simple. In addition, the terminal device can also switch information cards after receiving a switching instruction to display more information to a user.

An embodiment of the application further provides an application program for performing the method for displaying information when being executed. The method comprises:

receiving a display instruction and displaying at least one information card on a display screen of a terminal equipment;

receiving a switching instruction;

if the switching instruction is to slide rightwards, at least one new information card is moved into the display screen from left to right when moving the at least one information card rightwards out of the display screen;

if the switching instruction is to slide leftwards, at least one new information card is moved into the display screen from right to left when moving the at least one information card leftwards out of the display screen;

wherein, the size of the information card is smaller than the size of the display screen, the information card includes information to be displayed.

By applying the embodiments of the present application, at least one information card is displayed on a display screen after receiving a display instruction, the information card including information to be displayed. It means that an information card is displayed as long as a terminal equipment receives a display instruction, so that a user can browse information displayed on an information card without entering an application, the operation being simple. In addition, the terminal device can also switch information cards after receiving a switching instruction to display more information to a user.

An embodiment of the application further provides a storage medium for storing application programs, which are used to perform the method for displaying information when being executed, the method comprises:

receiving a display instruction and displaying at least one information card on a display screen of a terminal equipment;

receiving a switching instruction;

if the switching instruction is to slide rightwards, at least one new information card is moved into the display screen from left to right when moving the at least one information card rightwards out of the display screen;

if the switching instruction is to slide leftwards, at least one new information card is moved into the display screen from right to left when moving the at least one information card leftwards out of the display screen;

wherein, the size of the information card is smaller than the size of the display screen, the information card includes information to be displayed.

By applying the embodiments of the present application, at least one information card is displayed on a display screen of a terminal equipment after a display instruction is received, the information card including information to be displayed. That is, an information card is displayed as long as a terminal equipment receives a display instruction, such that a user can browse information displayed on the information card without entering an application, and thus the operation is simple. In addition, the terminal device can also switch information cards after receiving a switching instruction to display more information to a user.

Embodiments of a device and terminal equipment are simply described since they are essentially similar to embodiments of a method, and the related parts could refer to the parts of the description of embodiments of a method.

It should be noted that the relationship terms herein such as “first”, “second” and the like are only used to distinguish one entity or operation from another entity or operation, but do not necessarily require or imply that there is actual relationship or order between these entities or operations. Moreover, the terms “include”, “comprise” or any variants thereof are intended to cover a non-exclusive inclusion, such that processes, methods, articles or devices comprising a series of elements comprise not only those elements listed, but also other elements not specifically listed or the elements intrinsic to these processes, methods, articles, or devices. Without further limitations, elements limited by the wording “comprise(s) a/an . . . ” do not exclude that there are additional identical elements in the processes, methods, articles, or devices which comprise the listed elements.

All embodiments in the description are described in a correlated manner, and identical or similar parts in various embodiments can be referred to one another, the description for each embodiment all focusing on the differences with other embodiments. Especially, the embodiments of a device are briefly described and reference can be made to the description of the embodiments of a method for its related contents since the embodiments of the device are substantially similar to those of the method.

Those ordinary skilled in the art can understand that all or parts of the steps in the above method embodiments can be accomplished through programs instructing related hardware. The programs can be stored in a computer-readable storage medium, such as ROM/RAM, magnetic disc, optical disk and the like.

The embodiments described above are just preferable embodiments of the present application, and not indented to limit the protection scope of the present application. Any modifications, alternatives, improvements or the like within the spirit and principle of the present application shall fall into the protection scope of the present application.

1. A method for displaying information, wherein the method comprises steps of:
receiving a display instruction and displaying at least one information card on a display screen of a terminal equipment;
receiving a switching instruction;
if the switching instruction is to slide rightwards, at least one new information card is moved into the display screen from left to right when moving the at least one information card rightwards out of the display screen;
if the switching instruction is to slide leftwards, at least one new information card is moved into the display screen from right to left when moving the at least one information card leftwards out of the display screen;
wherein, the size of the information card is smaller than the size of the display screen, the information card includes information to be displayed,
wherein the information card comprises a multimedia resource display area and/or a text area, wherein the multimedia resource display area is used for displaying multimedia resource information, and the text area is used for displaying text information, and
wherein the method further comprises: receiving a first interaction instruction for the information card, and performing an operation corresponding to the first interaction instruction, and
wherein the step of performing an operation corresponding to the first interaction instruction comprises: flipping over the text area of the information card and displaying text information related to the text information of the text area, on the back of the information card when the first interaction instruction is an instruction of flipping over a card, wherein when the information card is flipped over, only the text area is flipped over while the multimedia resource display area is not flipped over, and
wherein the method further comprises:
receiving a second interaction instruction, which is an instruction for a new window of the display screen; and
displaying information corresponding to the second interaction instruction,
wherein, the step of performing an operation corresponding to the first interaction instruction comprises moving the information card upward or downward out of the display screen when the first interaction instruction is an instruction of moving out a card, and when the information card is moved out of the display screen, marking this kind of information, and wherein upon displaying information cards, this kind of information card is deleted or is not generated any more.

2. The method according to claim 1, wherein the step of receiving a display instruction and displaying at least one information card on a display screen of a terminal equipment comprises:
receiving a display instruction input by a user and displaying at least one information card on a display screen of a terminal equipment;
wherein the information to be displayed includes information obtained from network side according to the display instruction input by the user.

3. The method according to claim 1, wherein the method further comprises:
displaying prompt information in a preset position on the display screen, the prompt information being used for prompting the presence of other information cards.

4. The method according to claim 3, wherein the step of displaying prompt information in a preset position on the display screen comprises:
displaying a prompt card at the left boundary and/or the right boundary of the display screen, wherein the size of the prompt card is set according to the remaining size of the display screen, the remaining size is the size obtained by subtracting the size of the information card from the size of the display screen.

5. The method according to claim 1, wherein the step of receiving a switching instruction comprises one of the followings:
receiving a switching instruction input by a user; and
receiving a switching instruction generated according to a predefined rule.

6. The method according to claim 1, wherein the step of displaying at least one information card on a display screen of a terminal equipment comprises:
displaying the at least one information card on the display screen in a manner in which at least one information card is arranged horizontally.

7. (canceled)

8. (canceled)

9. (canceled)

10. The method according to claim 1, wherein the step of performing an operation corresponding to the first interaction instruction comprising one of the followings:
adjusting the size of the information card on the display screen when the first interaction instruction is an instruction of adjusting card size;
adjusting the number of the information cards displayed on the display screen when the first interaction instruction is an instruction of adjusting the number of cards; and
adjusting the display state of information in the information card when the first interaction instruction is an instruction of adjusting information state.

11. The method according to claim 1, wherein the first interaction instruction is an instruction of displaying related information, the step of performing an operation corresponding to the first interaction instruction comprising:
displaying information related to the information card in a new window of the display screen.

12. The method according to claim 1, wherein the first interaction instruction is a layout adjusting instruction, the step of performing an operation corresponding to the first interaction instruction comprising:
obtaining at least two summary cards to be displayed; and
replacing the information card currently being displayed with the at least two summary cards.

13. The method according to claim 12, wherein, the at least two summary cards are arranged in a spaced manner.

14. The method according to claim 13, wherein, the at least two summary cards are uniformly arranged in an equally spaced manner; and one row or one column of summary cards corresponds to one type of information.

15. The method according to claim 12, wherein the at least two summary cards are displayed in one of the following ways:
the at least two summary cards are displayed in at least one column as a summary card queue, wherein the summary cards in the summary card queue are arranged in a non-overlapping manner; and
the at least two summary cards are displayed in at least one row as a summary card queue.

16. A terminal equipment, wherein the terminal equipment comprises:
a processor, a memory, communication interfaces, input/output interfaces and a bus, wherein the processor, the memory, the communication interfaces and the input/output interfaces are connected to the bus respectively, the memory is used for storing executable program codes; the processor executes a program corresponding to the executable program codes by reading the executable program codes stored in the memory, so as to perform a method for displaying information, which method comprises steps of:
receiving a display instruction and displaying at least one information card on a display screen of the terminal equipment;
receiving a switching instruction;
if the switching instruction is to slide rightwards, at least one new information card is moved into the display screen from left to right when moving the at least one information card rightwards out of the display screen;
if the switching instruction is to slide leftwards, at least one new information card is moved into the display screen from right to left when moving the at least one information card leftwards out of the display screen;
wherein, the size of the information card is smaller than the size of the display screen, the information card includes information to be displayed,
wherein the information card comprises a multimedia resource display area and/or a text area, wherein the multimedia resource display area is used for displaying multimedia resource information, and the text area is used for displaying text information, and
wherein the method further comprises: receiving a first interaction instruction for the information card, and performing an operation corresponding to the first interaction instruction, and
wherein the step of performing an operation corresponding to the first interaction instruction comprises: flipping over the text area of the information card and displaying text information related to the text information of the text area, on the back of the information card when the first interaction instruction is an instruction of flipping over a card, wherein when the information card is flipped over, only the text area is flipped over while the multimedia resource display area is not flipped over; and;
wherein the method further comprises:
receiving a second interaction instruction, which is an instruction for a new window of the display screen; and
displaying information corresponding to the second interaction instruction,
wherein, the step of performing an operation corresponding to the first interaction instruction comprises moving the information card upward or downward out of the display screen when the first interaction instruction is an instruction of moving out a card, and when the information card is moved out of the display screen, marking this kind of information, and wherein upon displaying information cards, this kind of information card is deleted or is not generated any more.

17. The terminal equipment according to claim 16, wherein the step of receiving a display instruction and displaying at least one information card on a display screen of the terminal equipment comprises:
receiving a display instruction input by a user and displaying at least one information card on a display screen of the terminal equipment;
wherein the information to be displayed includes information obtained from network side according to the display instruction input by the user.

18. The terminal equipment according to claim 16, wherein the method for displaying information further comprises:
displaying prompt information in a preset position on the display screen, the prompt information being used for prompting the presence of other information cards.

19. The terminal equipment according to claim 18, wherein the step of displaying prompt information in a preset position on the display screen comprises:
displaying a prompt card at the left boundary and/or the right boundary of the display screen, wherein the size of the prompt card is set according to the remaining size of the display screen, the remaining size is the size obtained by subtracting the size of the information card from the size of the display screen.

20. The terminal equipment according to claim 16, wherein the step of receiving a switching instruction comprises one of the followings:
receiving a switching instruction input by a user; and
receiving a switching instruction generated according to a predefined rule.

21. (canceled)

22. (canceled)

23. (canceled)

24. The terminal equipment according to claim 16, wherein the step of performing an operation corresponding to the first interaction instruction comprising one of the followings:
adjusting the size of the information card on the display screen when the first interaction instruction is an instruction of adjusting card size;
adjusting the number of the information cards displayed on the display screen when the first interaction instruction is an instruction of adjusting the number of cards; and
adjusting the display state of information in the information card when the first interaction instruction is an instruction of adjusting information state.

25. The terminal equipment according to claim 16, wherein the first interaction instruction is an instruction of displaying related information, the step of performing an operation corresponding to the first interaction instruction comprising:
displaying information related to the information card in a new window of the display screen.

26. The terminal equipment according to claim 16, wherein the first interaction instruction is a layout adjusting instruction, the step of performing an operation corresponding to the first interaction instruction comprising:
obtaining at least two summary cards to be displayed; and
replacing the information card currently being displayed with the at least two summary cards.

27. The terminal equipment according to claim 26, wherein, the at least two summary cards are arranged in a spaced manner.

28. The terminal equipment according to claim 27, wherein, the at least two summary cards are uniformly arranged in an equally spaced manner; and one row or one column of summary cards corresponds to one type of information.

29. The terminal equipment according to claim 26, wherein the at least two summary cards are displayed in one of the following ways:
the at least two summary cards are displayed in at least one column as a summary card queue, wherein the summary cards in the summary card queue are arranged in a non-overlapping manner; and
the at least two summary cards are displayed in at least one row as a summary card queue.

30. A non-transitory storage medium, wherein the storage medium is used for storing application programs, which application programs are used to perform the method for displaying information of claim 1 when being executed.

31. (canceled)

32. (canceled)
